(19) United States
(12) Patent Application Publication
(10) Pub. No.: US 2010/0321371 A1
(43) Pub. Date: Dec. 23, 2010

(54) METHOD OF DRIVING PLASMA DISPLAY PANEL, AND PLASMA DISPLAY APPARATUS

(76) Inventors: Satoshi Kominami, Osaka (JP); Toshikazu Wakabayashi, Osaka (JP); Masumi Izuchi, Osaka (JP); Junko Matsushita, Osaka (JP); Yasuhiro Arai, Osaka (JP); Hiroyasu Makino, Osaka (JP)

Correspondence Address: MCDERMOTT WILL & EMERY LLP, 600 13TH STREET, NW, WASHINGTON, DC, 20005-3096, US

(21) Appl. No.: 12/671,392

(22) PCT Filed: Jun. 4, 2009
(86) PCT No.: PCT/JP2009/002518

§ 371 Date: Jan. 29, 2010

(30) Foreign Application Priority Data
Jun. 5, 2008 (JP) 2008-147751
Jun. 3, 2009 (JP) 2009-133922

(51) Int. Cl. G09G 5/00

(52) U.S. Cl. 345/212

(57) ABSTRACT

A method of driving a plasma display panel of the present invention, is a driving method of a display panel including plural display electrode pairs (24) each including a scan electrode (22) and a sustain electrode (23) extending along each other, plural data electrodes (32) crossing the plural display electrode pairs (24) and discharge cells respectively formed at positions where the display electrode pairs (24) and the data electrodes (32) cross each other. The method comprises applying a last sustain pulse to the scan electrode (22) in a sustain period when a sustain voltage pulse is applied alternately to the scan electrode (22) and to the sustain electrode (23); then applying to the scan electrode (22) a first ramp voltage having a first ramp waveform which is opposite in polarity to the last sustain voltage pulse; and applying to the sustain electrode (23) a second ramp voltage having a second ramp waveform which is opposite in polarity to the first ramp voltage such that before one of the first and second ramp waveforms reaches a predetermined voltage and finishes rising, the other of the first and second ramp waveforms starts rising.

### RELATED APPLICATIONS

This application is the U.S. National Phase under 35 U.S.C. §371 of International Application No. PCT/JP2009/002518, filed on Jun. 4, 2009, which in turn claims the benefit of Japanese Application Nos. 2008-147751, filed on Jun. 5, 2008 and 2009-133922, filed on Jun. 3, 2009, the disclosures of which Applications are incorporated by reference herein.

### TECHNICAL FIELD

The present invention relates to a method of driving a plasma display panel, and a plasma display apparatus which is a display apparatus using the plasma display panel.

### BACKGROUND ART

These days, in plasma display panels (hereinafter referred to as PDPs), AC surface discharge type PDPs are typical. In the AC surface discharge type PDP, a front substrate and a back substrate are placed so as to face each other to form a number of discharge cells. Hereinafter, the configuration of the AC surface discharge type PDP will be described.

On the front substrate, plural display electrode pairs each including a scan electrode and a sustain electrode are formed so as to extend in parallel with each other. In addition, on the front substrate, a dielectric layer and a protective layer are stacked so as to cover the display electrode pairs. On the back substrate, plural data electrodes are formed so as to extend in parallel with each other. On the back substrate, a dielectric layer is formed so as to cover the data electrodes. On the dielectric layer, lattice-shaped separating walls are formed. In a space formed between the upper surface of the dielectric layer and the side surface of the separating wall, a phosphor layer for emitting light of red, green and blue is provided.

In the front substrate and the back substrate formed as described above, the display electrode pairs and the data electrodes are placed so as to face each other and so as to sandwich a small discharge space therebetween such that they three-dimensionally cross each other. The outer peripheral portions of the front substrate and the back substrate are bonded to each other by a sealing material. A discharge gas is filled into an inner discharge space. In this manner, the discharge cells are formed at portions where the display electrode pairs and the data electrodes cross each other. Inside the respective discharge cells, gas discharge generates ultraviolet light which causes respective phosphors to be excited to emit light. Thus, color display is performed.

In a driving method of the PDP, a sub-field method is used, in which one field ( 1/60 second=about 16.7 ms) is divided into plural sub-fields and gray scale display is performed using a combination of sub-fields for emitting light. Each sub-field includes a reset period, a write period, and a sustain period.

In the reset period, a predetermined voltage is applied to the scan electrodes and the sustain electrodes of the display electrode pairs to generate reset discharge, forming wall charge necessary for a next write operation on each of electrodes. In the write period, a scan voltage pulse (hereinafter simply referred to as scan pulse) is sequentially applied to the scan electrodes, and a write voltage pulse (hereinafter simply referred to as write pulse) is selectively applied to data electrodes of discharge cells according to an image to be displayed to generate write discharge, forming wall charge on the each of the electrodes. In the sustain period, a sustain voltage pulse (hereinafter simply referred to as sustain pulse) is applied alternately to the display electrode pairs including the scan electrodes and the sustain electrodes to generate sustain discharge in the discharge cells which generated write discharge, exciting a discharge gas. By the ultraviolet light generated when the excited discharge gas transitions to a stable state, the phosphor layers of the associated discharge cells are excited to generate visible light. Thus, image display is performed.

In the sub-field method, an ADS method (address-display separated method) is commonly used, in which the write period and the sustain period are completely separated in time from each other. For example, Patent document 1 discloses a configuration in which one field is divided into eight sub-fields to achieve 256 gray scales and an image is displayed. In the ADS method, there are no timings when the write discharge and the sustain discharge occur simultaneously in the same discharge cell. Therefore, the PDP is driven under an optimal condition for the write discharge in the write period and under an optimal condition for the sustain discharge in the sustain period. For this reason, discharge control is relatively easy and a driving margin of the PDP can be set to a large one.

FIG. 12 is a view showing driving voltage waveforms of the conventional ADS method, and voltage waveforms applied to an address electrode (corresponding to the data electrode), a scanning electrode (corresponding to the scan electrode), and a sustaining electrode (corresponding to the sustain electrode) in a reset period, an address period (corresponding to the write period), and a sustain period in each sub-field. FIG. 12 corresponds to FIG. 2 of Patent document 1.

As shown in FIG. 12, in the reset period, a rising ramp voltage gradually rising and a falling ramp voltage gradually falling are sequentially applied to the scanning electrodes (scan electrodes) to generate weak discharge within the discharge cells and the wall charge on each electrode is controlled. Thus, the reset of the discharge cells is performed. In general, the reset of a first sub-field is performed for all of the discharge cells (called total reset), and therefore the rising ramp waveform of a relatively high voltage is applied. In a second sub-field and the following sub-fields, the reset (called selective reset) is performed for the discharge cells which were turned ON in their previous sub-fields, and therefore, the rising ramp voltage waveform of a relatively low voltage is applied.

In the address period, a negative pulse voltage is applied to the scanning electrodes and a positive pulse voltage is applied to the address electrodes, to generate write discharge. Thus, the discharge cells to be turned ON are selected.

In the sustain period, a positive sustain pulse voltage is applied alternately to the scanning electrodes and to the sustaining electrodes, to turn ON the discharge cells selected in the address period.

In recent years, there has been a demand for displays with higher definition. The PDPs have been developed at a high pace to provide higher definition, from the conventional HD resolution (number of lines: 768) to full HD resolution (the number of lines: 1080). Furthermore, in a market, there has been a demand for super-high definition, so-called 4K2K (the number of lines: 2160) and 8K4K (the number of lines: 4320). Such higher-definition, i.e., an increase in the number of lines directly leads to an increase in the time period required for the write period. For example, if the number of lines doubles, then the time period required for the write period doubles. Despite this, the time period corresponding to one field is fixed. Therefore, if the time period required for the write period increases, then other period must be shortened because of the increase in the write period. For example, it becomes necessary to reduce the number of sub-fields and to reduce the number of sustain pulses, degrading an image quality.

Accordingly, development for improving the property of the PDPs is made every day in order to reduce the time period required for the write period. Meanwhile, for the super-high definition PDPs such as, in particular, 4K2K (the number of lines:2160) and 8K4K (the number of lines: 4320), a driving method which can maximize the length of the time period required for the write period is investigated. For example, with a view to increasing the length of the time period required for the write period, Patent document 2 discloses a driving method capable of reducing the time period required for the reset period and Patent document 3 discloses a driving method capable of omitting the reset period.

### PRIOR ART DOCUMENT

### Patent Document

Patent document 1: Japanese Laid-Open Patent Application Publication No. 2004-271877 (particular FIG. 2)

Patent document 2: Japanese Laid-Open Patent Application Publication No. 2004-62207 (particular FIG. 5)

Patent document 3: Japanese Laid-Open Patent Application Publication No. 2004-326074 (particular FIG. 5)

### SUMMARY OF THE INVENTION

### Problems To Be Solved By the Invention

FIG. 13 is a view showing driving voltage waveforms according to the driving method capable of reducing the time period required for the reset period, and voltage waveforms applied to Y electrodes (corresponding to the scan electrode) and X electrodes (corresponding to the sustain electrode) in a resetting period (corresponding to the reset period), a write-in discharge period (corresponding to the write period), and a sustain period. FIG. 13 corresponds to FIG. 5 of Patent document 2. The voltage waveforms shown in FIG. 13 are different from the voltage waveforms of FIG. 12 in that each of a rising ramp voltage and a falling ramp voltage sequentially applied to the scan electrodes (Y electrode) in the reset period has two-stage ramps. Patent document 2 discloses that the time period required for the reset period can be reduced and stable reset is achieved because of such a configuration.

FIG. 14 is a view showing driving voltage waveforms in the driving method capable of omitting the reset period, and voltage waveforms applied to Y electrodes (corresponding to the sustain electrode), X electrodes (corresponding to the sustain electrode), and A electrode (corresponding to the data electrode) in an address period (corresponding to a reset period) and a sustaining period (corresponding to the scan electrode). FIG. 14 corresponds to FIG. 5 of Patent document 3. Patent document 3 discloses that the reset period can be omitted by applying a pulse voltage Vr with a higher voltage than a sustain pulse to the Y electrodes (corresponding to the scan electrode) after the write period (address period), as shown in FIG. 14.

However, in the configuration shown in FIG. 13, since the ramp of the rising ramp voltage and the ramp of the falling ramp voltage applied in the reset period are each set to have two stages, the time period required for the reset period can be reduced to some extent, but there is a limitation on further reduction of the reset period. In addition, a circuit configuration for achieving the above configuration may be very complicated.

Furthermore, in the configuration shown in FIG. 14, since the reset using the rising ramp voltage and the falling ramp voltage is not carried out, it may be difficult to perform stable write while obviating a state difference between the discharge cells due to the ON-state in the previous sub-fields, a manufacture variation in the discharge cells, etc. Therefore, this configuration may be effective to the PDPs including few discharge cells (i.e., low-resolution PDP). However, it would be more difficult to omit the reset period in the PDPs including more discharge cells (i.e., higher-definition PDPs).

The present invention is directed to solving the problem associated with the prior arts, and an object of the present invention is to provide a novel driving method of a plasma display panel, which is capable of stably performing reset and capable of reducing the time period required for the reset period, in particular, time period required for selective reset, and a plasma display apparatus using the driving method.

### Means For Solving the Problem

To solve the above mentioned problem associated with the prior art, a method of driving a plasma display panel of the present invention including plural display electrode pairs each including a scan electrode and a sustain electrode extending along each other, plural data electrodes crossing the plural display electrode pairs and discharge cells respectively formed at positions where the display electrode pairs and the data electrodes cross each other, comprises applying a last sustain voltage pulse to the scan electrode in a sustain period when a sustain voltage pulse is applied alternately to the scan electrode and to the sustain electrode; then applying to the scan electrode a first ramp voltage having a first ramp waveform which is opposite in polarity to the last sustain voltage pulse; and applying to the sustain electrode a second ramp voltage having a second ramp waveform which is opposite in polarity to the first ramp voltage such that before one of the first and second ramp waveforms reaches a predetermined voltage and finishes rising, the other of the first and second ramp waveforms starts rising.

With this method, it is possible to provide a novel plasma display panel driving method which is capable of performing stable reset and capable of reducing a time period required for the reset period, in particular, a selective reset period.

In the method of driving the plasma display panel of the present invention, it is preferable that the first and second ramp voltages are applied such that the second ramp waveform reaches a predetermined first voltage and finishes rising before the first ramp waveform reaches the predetermined voltage and finishes rising.

In the method of driving the plasma display panel of the present invention, it is preferable that after the second ramp voltage reaches the first voltage, a second voltage lower than the first voltage is applied to the sustain electrode.

In the method of driving the plasma display panel of the present invention, it is preferable that a time period from when the last sustain voltage pulse starts falling until the last sustain voltage pulse finishes falling is longer than a time period from when other sustain voltage pulses start falling until the other sustain voltage pulses finish falling.

In the method of driving the plasma display panel of the present invention, it is preferable that a pulse width of the last sustain voltage pulse is changeable with respect to pulse widths of other sustain voltage pulses.

A plasma display apparatus of the present invention comprises plural display electrode pairs each including a scan electrode and a sustain electrode extending along each other; plural data electrodes crossing the plural display electrode pairs; discharge cells respectively formed at positions where the display electrode pairs and the data electrodes cross each other; and a control means configured to control a voltage applied to the display electrode pairs; wherein the control means is configured to apply a last sustain voltage pulse to the scan electrode in a sustain period when a sustain voltage pulse is applied alternately to the scan electrode and to the sustain electrode; then apply to the scan electrode a first ramp voltage having a first ramp waveform which is opposite in polarity to the last sustain voltage pulse; and apply to the sustain electrode a second ramp voltage having a second ramp waveform which is opposite in polarity to the first ramp voltage such that before one of the first and second ramp waveforms reaches a predetermined voltage and finishes rising, the other of the first and second ramp waveforms starts rising.

With this configuration, it is possible to provide a novel plasma display apparatus which is capable of performing stable reset and capable of reducing a time period required for the reset period, i.e., in particular, the selective reset period.

It is preferable that the plasma display apparatus of the present invention further comprises a first ramp voltage application means which is connected to the scan electrode and applies to the scan electrode the first ramp voltage having the first ramp waveform; and a second ramp voltage application means which is connected to the sustain electrode and applies to the sustain electrode the second ramp voltage having the second ramp waveform; wherein the control means causes the second ramp voltage application means to generate the second ramp voltage such that the second ramp waveform reaches a predetermined first voltage and finishes rising before the first ramp waveform of the first ramp voltage generated by the first ramp voltage application means reaches the predetermined voltage and finishes rising.

It is preferable that the plasma display apparatus of the present invention further comprises a constant voltage application means which is connected to the sustain electrode and applies to the sustain electrode a constant voltage of a second voltage lower than the first voltage; wherein the control means turns ON the constant voltage application means, when the second ramp voltage reaches the first voltage after the control means turns ON the second ramp voltage application means.

It is preferable that the plasma display apparatus of the present invention further comprises a sustain voltage pulse application means which is connected to the scan electrode and applies a sustain voltage pulse to the scan electrode; wherein the control means is configured to set, a time period from when the last sustain voltage pulse starts falling until the last sustain voltage pulse finishes falling, longer than a time period from when other sustain voltage pulses start falling until the other sustain voltage pulses finish falling.

It is preferable that the plasma display apparatus of the present invention further comprises a sustain voltage pulse application means which is connected to the scan electrode and applies a sustain voltage pulse to the scan electrode; wherein the control means is configured to change a pulse width of the last sustain voltage pulse with respect to pulse widths of other sustain voltage pulses.

The above and further objects, features and advantages of the invention will more fully be apparent from the following preferred detailed description with reference to the accompanying drawings.

### Effects of the Invention

In accordance with the present invention, it is possible to provide a novel method of driving a plasma display panel, which is capable of stably performing reset and capable of reducing the time period required for the reset period, in particular, time period required for selective reset, and a plasma display apparatus using the driving method.

### BRIEF DESCRIPTION OF THE DRAWINGS

FIG. 1 is an exploded perspective view showing a structure of a panel according to Embodiment 1 of the present invention.

FIG. 2 is a view of electrode arrangement of the panel according to Embodiment 1 of the present invention.

FIG. 3 is a view showing driving voltage waveforms of a driving method according to Embodiment 1 of the present invention.

FIG. 4 is a circuit block diagram of a plasma display apparatus according to Embodiment 1 of the present invention.

FIG. 5 is a circuit diagram of a scan electrode driving circuit of the plasma display apparatus according to Embodiment 1 of the present invention.

FIG. 6 is a circuit diagram of a sustain electrode driving circuit of the plasma display apparatus according to Embodiment 1 of the present invention.

FIG. 7 is a view showing driving voltage waveforms of a driving method according to Embodiment 2 of the present invention.

FIG. 8 is a view showing driving voltage waveforms of a driving method according to Embodiment 3 of the present invention.

FIG. 9 is a circuit diagram of a sustain electrode driving circuit according to Embodiment 3 of the present invention.

FIG. 10 is a view showing driving voltage waveforms of a driving method according to Embodiment 4 of the present invention.

FIG. 11 is a view showing driving voltage waveforms of a driving method according to Embodiment 5 of the present invention.

FIG. 12 is a view showing driving voltage waveforms of a conventional driving method.

FIG. 13 is a view showing driving voltage waveforms of a conventional driving method.

FIG. 14 is a view showing driving voltage waveforms of a conventional driving method.

### EMBODIMENTS FOR CARRYING OUT THE INVENTION

Hereinafter, the embodiments of the present invention will be described in detail with reference to the drawings.

### Embodiment 1

<Structure of PDP>

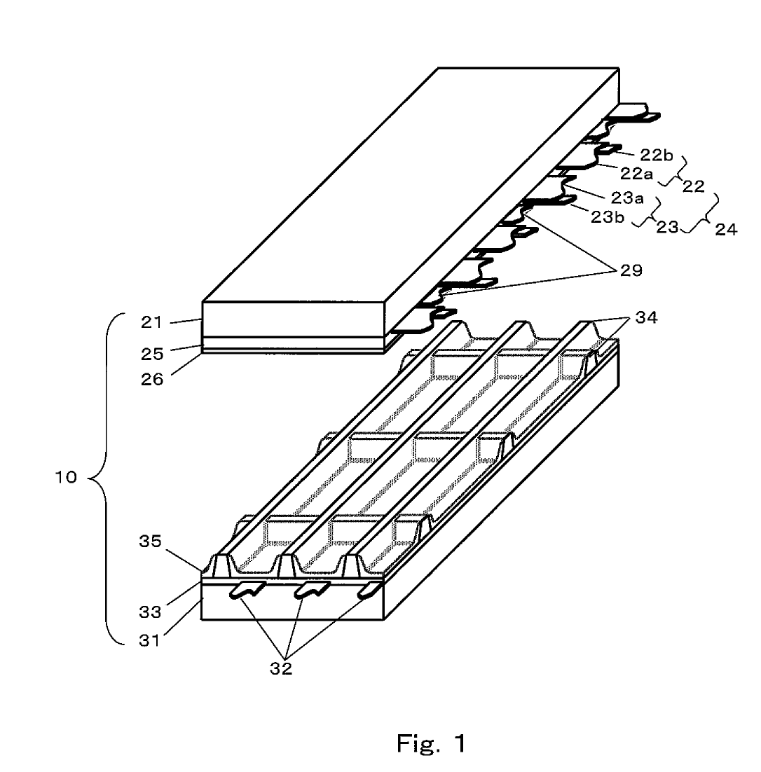

FIG. 1 is an exploded perspective view showing a structure of a plasma display panel (PDP) according to Embodiment 1 of the present invention. As shown in FIG. 1, plural display electrode pairs 24 each including a scan electrode 22 and a sustain electrode 23 are formed on a glass-made front substrate 21. Each scan electrode 22 has a transparent electrode 22a with a large width and each sustain electrode 23 has a transparent electrode 23a with a large width to generate discharge in a discharge gap between the scan electrode 22 and the sustain electrode 23 and to take out light therefrom. A bus electrode 22b with a small width is stacked on the transparent electrode 22a and a bus electrode 23b with a small width is stacked on the transparent electrode 23b such that they are respectively positioned distant from the discharge gap. A black stripe 29 is provided between adjacent display electrode pairs 24 to block light. A dielectric layer 25 and a protective layer 26 are stacked on the front substrate 21 so as to cover the scan electrodes 22, the sustain electrodes 23 and the black stripes 29.

Plural data electrodes 32 are formed to extend in parallel with each other on a back substrate 31. A dielectric layer 33 is formed on the back substrate 31 so as to cover the data electrodes 32. Lattice-shaped separating walls 34 are formed on the dielectric layer 33. A phosphor layer 35 is provided in a space defined by the upper surface of the dielectric layer 33 and the side surfaces of the separating walls 34 to emit light of red, green and blue.

The front substrate 21 and the back substrate 31 formed as described above are disposed so as to face each other and so as to sandwich a small discharge space such that the display electrode pairs 24 three-dimensionally cross the data electrodes 32. The outer peripheral portions of the front substrate 21 and the back substrate 31 are sealed by a sealing material such as glass frit. The inner discharge space is separated into plural spaces by the separating walls 34. For example, a mixture gas of neon and xenon is filled into the inner discharge space. In this way, a panel 10 according to Embodiment 1 is constructed, and discharge cells are formed at portions where the display electrode pairs 24 and the data electrodes 32 cross each other. Within the respective discharge cells, ultraviolet light generated by the gas discharge causes respective phosphors to be excited so as to emit light, and thereby color display is performed. The structure of the panel 10 is not limited to the above described structure, but stripe-shaped separating walls 34 may be provided, for example.

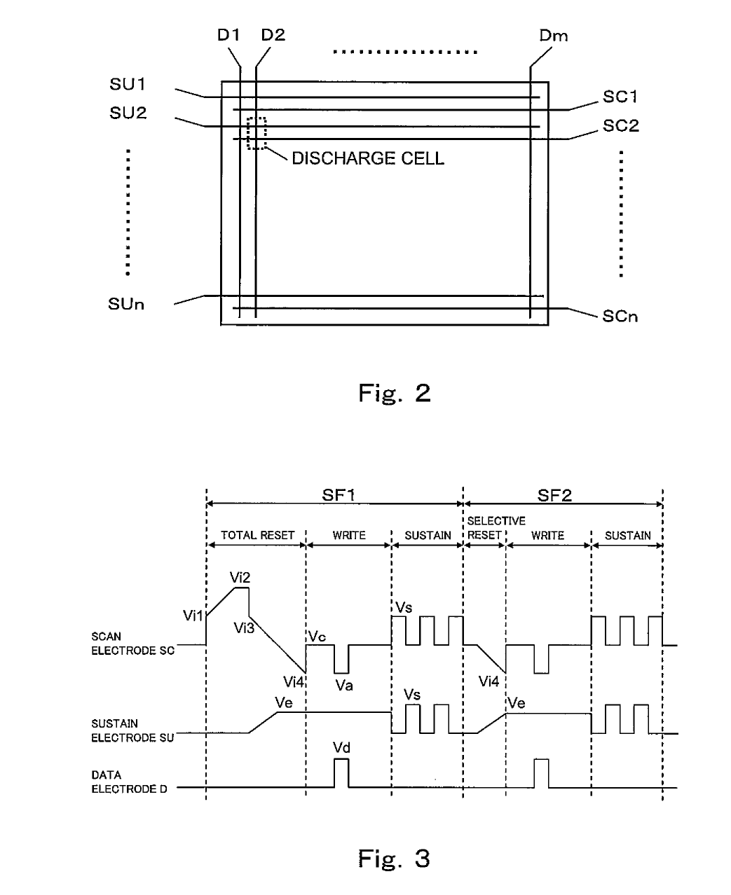

FIG. 2 is a view of electrode arrangement of the panel 10 shown in FIG. 1. As shown in FIG. 2, in the panel 10 according to Embodiment 1, the scan electrodes 22 (SC1˜SCn) and the sustain electrodes 23 (SU1˜SUn) are arranged in a row direction, and the data electrodes 32 (D1˜Dm) are arranged in a column direction. As shown in FIG. 2, a discharge cell is formed at a portion where the pair of scan electrode SC2 and sustain electrode SU2 cross one data electrode D2, for example, and (m×n) discharge cells are formed as a whole within the discharge space.

<Driving Method of PDP>

FIG. 3 is a view showing waveforms of driving voltage waveforms applied to the scan electrodes SC, the sustain electrodes SU, and the data electrodes D of the panel 10 shown in FIGS. 1 and 2. In a reset period of a first sub-field (SF1), total reset is performed, in which all the discharge cells are reset. In a reset period of a second sub-field (SF2), selective reset is performed, in which only the discharge cells turned ON in the first sub-field (SF1) are reset. Whereas only the first sub-field (SF1) and the second sub-field (SF2) are illustrated in FIG. 3, the waveforms in a third sub-field (SF3) and the following sub-fields are basically the same as the waveforms in the second sub-field (SF2), and only the discharge cells which were turned ON in previous sub-fields are reset (selectively reset).

As shown in FIG. 3, in the total reset period of the first sub-field SF1, 0V is applied to the data electrodes D and to the sustain electrodes SU. A ramp voltage gradually rising from a voltage Vi1 which is not higher than a discharge start voltage toward a voltage Vi2 which exceeds the discharge start voltage with respect to the sustain electrodes SU, e.g., a ramp voltage increasing in 1 V/μsec is applied to the scan electrodes SC. During rising of the ramp voltage, weak reset discharge is generated between the scan electrodes SC and the sustain electrodes SU, and between the scan electrodes SC and the data electrodes D. Thereby, negative wall voltage is accumulated on the scan electrodes SC, while positive wall voltage is accumulated on the data electrodes D and on the sustain electrodes SU. As used herein, the term “wall voltage on electrode” refers to a voltage generated by wall charge accumulated on the dielectric layer, the protective layer, the phosphor layer, and the like covering the electrodes.

Next, a ramp voltage (first ramp voltage) gradually falling from a voltage Vi3 which is not higher than the discharge start voltage toward a voltage Vi4 which exceeds the discharge start voltage (the voltage exceeds so as to decrease), for example, a ramp voltage falling in 1 V/μsec is applied to the scan electrodes SC. At this time, a ramp voltage (second ramp voltage) gradually rising from a reference voltage toward a positive voltage Ve is applied to the sustain electrodes SU. During falling of the first ramp voltage, weak reset discharge is generated between the scan electrodes SC and the sustain electrodes SU, and between the scan electrodes SC and the data electrodes D. Thereby, the negative wall voltage on the scan electrodes SC and positive wall voltage on the sustain electrode SU are lowered, and the positive wall voltage on the data electrodes D are controlled to have a value suitable for a write operation.

Thereafter, a voltage Vc (reference voltage) is applied to the scan electrodes SC, terminating a reset operation for performing reset discharge for all of the discharge cells.

After the total reset period ends, a write period of the first sub-field SF1 starts. To be specific, in a state where a positive voltage Ve is applied to the sustain electrodes SU, a scan pulse having a negative voltage Va is applied to the scan electrodes SC, and a write pulse having a positive voltage Vd is applied to the data electrodes D of the discharge cells which should emit light. Hereinafter, the voltage Va of the scan pulse is referred to as a scan pulse voltage Va, and the voltage Vd of the write pulse is referred to as a write pulse voltage Vd. In this case, a voltage difference at a cross section on the data electrode D and the scan electrode SC of the discharge cell which should emit light is equal to a sum of a difference between external application voltages (write pulse voltage Vd−scan pulse voltage Va) and a difference between the wall voltage on the data electrode D and the wall voltage on the scan electrode SC and exceeds the discharge start voltage. Thereby, the discharge between the data electrode D and the scan electrode SC starts, which is followed by the discharge between the sustain electrode SU and the scan electrode SC, generating write discharge. As a result, the positive wall voltage is accumulated on the scan electrode SC, and the negative wall voltage is accumulated on the sustain electrode SU and on the data electrode D.

The above described write operation is repeated sequentially from the scan electrode SC1 on a first row to the scan electrode SCn on a n-th row for every row to cause the discharge cells which should emit light to selectively generate write discharge, forming the wall charge on each of the electrodes.

On the other hand, the discharge cells which were not applied with the write pulse of the voltage Vd do not generate write discharge, because the voltage at the cross sections of the data electrodes D and the scan electrodes SC does not exceed the discharge start voltage.

After the write period ends, the sustain period of the first sub-field SF1 starts. To be specific, the sustain pulse having a positive voltage Vs is applied to the scan electrodes SC and 0V (reference voltage Vc) is applied to the sustain electrodes SU. At this time, in the discharge cells which generated write discharge, the voltage difference between the scan electrode SC and the sustain electrode SU is equal to a sum of the sustain pulse voltage Vs and a difference between the wall voltage on the scan electrode SC and the wall voltage on the sustain electrode SU and exceeds the discharge start voltage. Thereby, sustain discharge is generated between the scan electrode SC and the sustain electrode SU, exciting a discharge gas. When the excited discharge gas transitions to a stable state, it generates ultraviolet light, which causes the phosphor layer 35 to emit light. As a result, the negative wall voltage is accumulated on the scan electrode SC, and the positive wall voltage is accumulated on the sustain electrode SU and on the data electrode D.

On the other hand, the discharge cells which did not generate write discharge in the write period, do not generate sustain discharge and keep the wall voltage on each of the electrodes at the end of the reset period.

Next, 0V(reference voltage Vc) is applied to the scan electrodes SC, and the sustain pulse of the positive voltage Vs is applied to the sustain electrodes SU. At this time, in the discharge cells which generated sustain discharge, since the electric potential difference between the sustain electrode SU and the scan electrode SC exceeds the discharge start voltage, the sustain discharge is generated again between the sustain electrode SU and the scan electrode SC. As a result, negative wall voltage is accumulated on the sustain electrodes SU and positive wall voltage is accumulated on the scan electrodes SC and the data electrodes D.

Thereafter, in the same manner, the sustain pulse of the voltage Vs is applied alternately to the scan electrodes SC and to the sustain electrodes SU, to generate an electric potential difference between the scan electrodes SC and the sustain electrodes SU. Thereby, the discharge cells which generated write discharge in the write period continue to generate sustain discharge. The last sustain pulse is applied to the scan electrodes SC.

After the sustain period of the first sub-field SF1 ends, the selective reset period of the second sub-field SF2 starts. To be specific, a first ramp voltage having a first ramp waveform which is opposite in polarity to the last sustain pulse is applied to the scan electrodes SC, and a second ramp voltage having a second ramp waveform which is opposite in polarity to the first ramp voltage is applied to the sustain electrodes SU in a period from when the first ramp waveform starts rising, reaches a predetermined voltage, and finishes rising. To be specific, the first ramp voltage having the first ramp waveform gradually falling toward the voltage Vi4 is applied to the scan electrodes SC, and the second ramp voltage having the second ramp waveform gradually rising toward the voltage Ve is applied to the sustain electrodes SU. In Embodiment 1, the first ramp voltage having the first ramp waveform and the second ramp voltage having the second ramp waveform start to be applied substantially at the same time and reach the voltage Vi4 and the voltage Ve, respectively, substantially at the same time. After that, the write period starts. The timings when the first ramp voltage and the second ramp voltage are applied are not restricted so long as the second ramp waveform starts rising before the first ramp waveform reaches the voltage Vi4 and finishes rising, or the first ramp waveform starts rising before the second ramp waveform reaches the voltage Ve and finishes rising. In other words, for example, the second ramp waveform may start rising after the first ramp waveform starts rising, or otherwise, the first ramp waveform may start rising after the second ramp waveform starts rising.

Since the last sustain pulse is applied to the scan electrodes SC in the discharge cells which were turned ON in the sustain period in the first sub-field SF1, the negative wall voltage is accumulated on the scan electrodes SC, and the positive wall voltage is accumulated on the sustain electrodes SU and the data electrodes D. For this reason, the first ramp voltage having the first ramp waveform causes generation of weak discharge between the scan electrodes SC and the data electrodes D so that the wall voltage on the scan electrodes SC and the wall voltage on the data electrodes D can be controlled to have values primarily suitable for the write operation. In addition, the ramp voltage waveform having the second ramp causes generation of weak discharge between the scan electrodes SC and the sustain electrodes SU so that the wall voltage on the scan electrodes SC and the wall voltage on the sustain electrodes SU can be controlled to have values primarily suitable for the write operation. Thereafter, a constant voltage of a voltage Vc is applied to the scan electrodes SC.

On the other hand, in the discharge cells which were not turned ON in the sustain period in the first sub-field SF1, weak discharge is not generated between the scan electrodes SC and the sustain electrodes SU, and between the scan electrodes SC and the data electrodes D, even though the first ramp voltage having the first ramp waveform and the second ramp voltage having the second ramp waveform are applied thereto. This is because wall voltage sufficient to generate weak discharge is not accumulated on the scan electrodes SC, the sustain electrodes SU, and the data electrodes D, since no discharge occurred in the sustain period. However, since the wall voltage in the reset period in a previous sub-field is preserved on the scan electrodes SC, the sustain electrodes SU and the data electrodes D of the above mentioned discharge cells, the wall voltage controlled to have a value suitable for the write operation is accumulated thereon.

Through the above explained procedure, preparation for the write operation in the second sub-field SF2 for all of the discharge cells terminates. Since the operation in the third sub-field SF3 and the following sub-fields is identical to the operation in the second sub-field SF2, description thereof is omitted.

In Embodiment 1, the ramp of the first ramp voltage waveform having the first ramp waveform and the ramp of the second ramp voltage having the second ramp waveform are each set to a ramp with which strong discharge is not generated between the scan electrode SC and the sustain electrode SU and between the scan electrode SC and the data electrode D. For example, the ramp of the first ramp waveform is set to about −0.5˜−2 V/μsec, and the ramp of the second ramp waveform is set to about 0.5˜100 V/μsec, although it depends on design factors (gas pressure, distance between electrodes, protective film material, etc) of a panel structure or the like. Generally, in the PDP, the distance between the scan electrode SC and the sustain electrode SU is shorter than the distance between the scan electrode SC and the data electrode D. Therefore, relatively weak discharge is more easily generated between the scan electrode SC and the sustain electrode SU, and strong discharge is not generated even if the ramp is steep to some extent. For this reason, as described above, the absolute value of the second ramp waveform can be set larger than the absolute value of the first ramp waveform, that is, the ramp can be made steeper.

<Effects>

In accordance with the driving method of the plasma display panel according to Embodiment 1, since the first ramp voltage having the first ramp waveform and the second ramp voltage having the second ramp waveform are simultaneously applied to the scan electrodes SC and to the sustain electrodes SU, respectively, the time period required for the operation in the selective reset period can be reduced almost by half, as compared to the conventional driving method. In addition, since the reset is performed using the ramp voltages, stable write operation can be performed.

<Configuration of Control System in Plasma Display Apparatus>

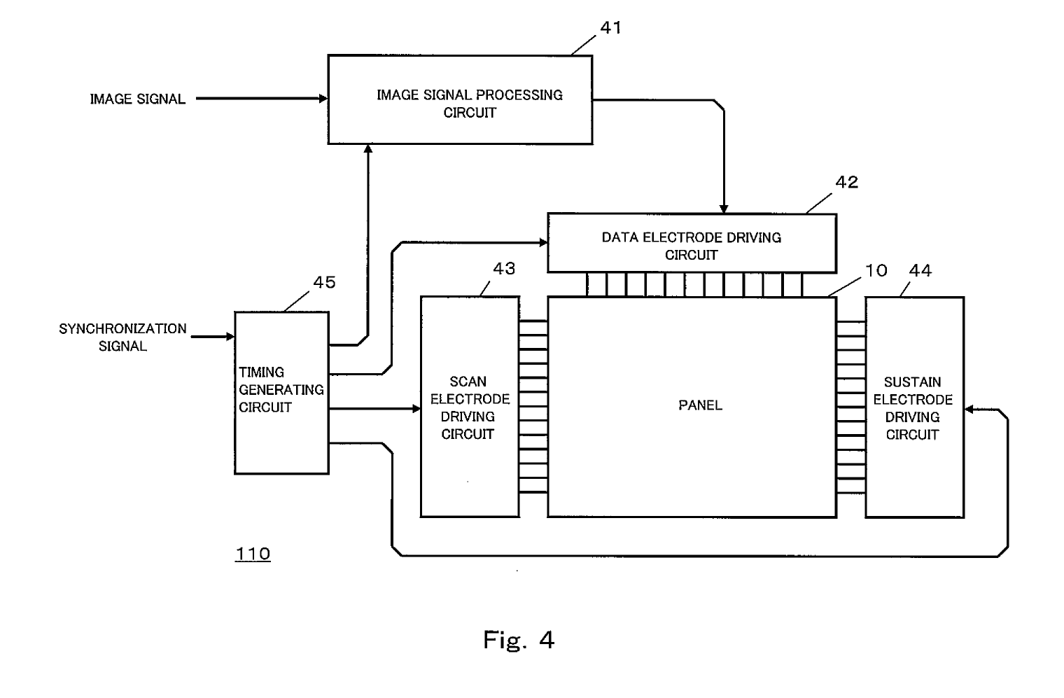

FIG. 4 is a circuit block diagram of a plasma display apparatus 110 according to Embodiment 1 of the present invention. As shown in FIG. 4, the plasma display apparatus 110 of Embodiment 1 comprises a panel 10, an image signal processing circuit 41, a data electrode driving circuit 42, a scan electrode driving circuit 43, a sustain electrode driving circuit 44, a timing generating circuit 45 and an electric power supply circuit (not shown) for supplying an electric power required for each circuit block.

The image signal processing circuit 41 converts an input image signal into image data exhibiting light emission and light non-emission in each sub-field. The data electrode driving circuit 42 has m switches through which the write pulse voltage Vd or 0V is applied to the respective data electrodes D1˜Dm, converts the image data output from the image processing circuit 41 into write pulse voltages corresponding to the data electrodes D1˜Dm and apply them to the data electrodes D1˜Dm.

The timing generating circuit 45 generates various timing signals used for controlling the operation of the circuits based on a horizontal synchronization signal and a vertical synchronization signal and send the timing signals to the associated circuits. The scan electrode driving circuit 43 drives the scan electrodes SC1˜SCn based on the timing signals sent from the timing generating circuit 45. The sustain electrode driving circuit 44 drives the sustain electrodes SU1˜SUn based on the timing signals sent from the timing generating circuit 45. In this way, the timing generating circuit 45, the scan electrode driving circuit 43 and the sustain electrode driving circuit 44 serve as control means for controlling the voltages applied to the display electrode pairs 24.

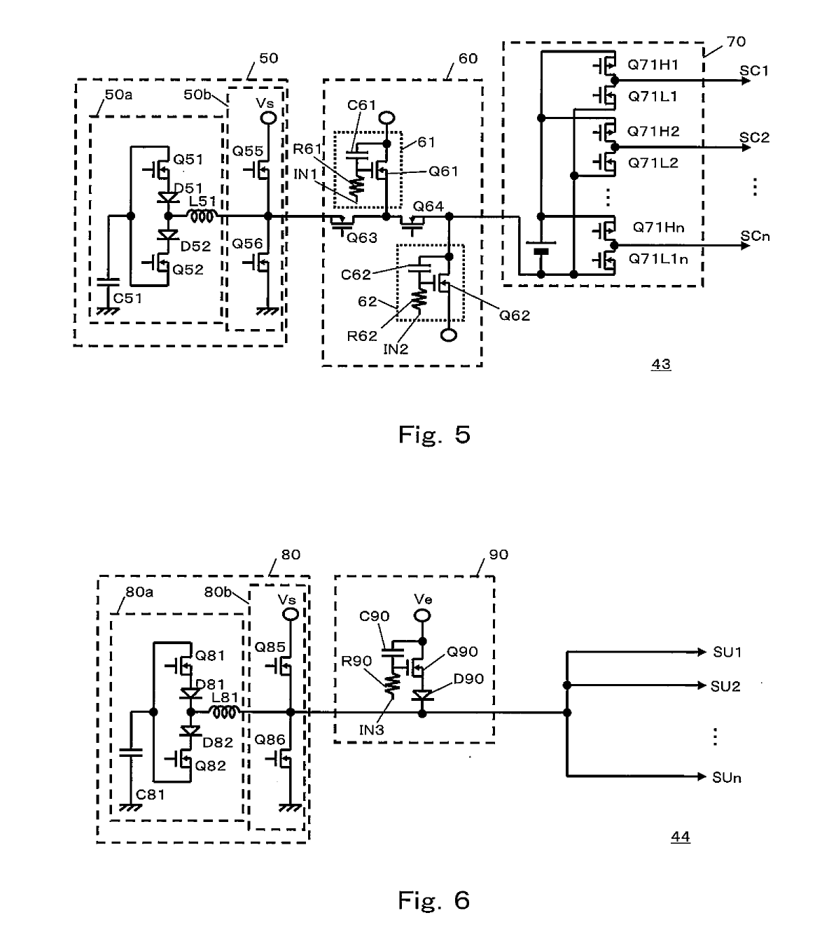

FIG. 5 is a circuit diagram of the scan electrode driving circuit 43 of the plasma display apparatus 110 according to Embodiment 1 of the present invention. As shown in FIG. 5, the scan electrode driving circuit 43 of the plasma display apparatus 110 of Embodiment 1 includes a sustain pulse generating circuit 50, a reset waveform generating circuit 60 and a scan pulse generating circuit 70.

The sustain pulse generating circuit 50 is a circuit for applying the sustain pulse voltage to the scan electrodes SC1˜SCn, and includes a capacitor C51 for electric power recovery, switching elements Q51 and Q52, back flow prevention diodes D51 and D52, and a resonance inductor L51, constituting an electric power recovery section 50a, and switching elements Q55 and Q56 constituting a voltage clamping section 50b.

The electric power recovery section 50a generates LC resonance between an interelectrode capacitance between the scan electrode 22 and the sustain electrode 23 forming the display electrode pair 24 and the inductor L51, to rise and fall the sustain pulse. At the rising of the sustain pulse, the switching element Q51 is turned ON and the switching element Q52 is turned OFF, to transfer charge accumulated in the capacitor C51 for electric power recovery to the interelectrode capacitance via the diode D51 and the inductor L51. At the falling of the sustain pulse, the switching element Q51 is turned OFF and the switching element Q52 is turned ON, to return charge accumulated in the interelectrode capacitance to the capacitor C51 for electric power recovery via the inductor L51 and the diode D52. In this way, the electric power recovery section 50a applies the voltage to the display electrode pair 24 by the LC resonance without being supplied with electric power from the electric power supply. Therefore, ideally, no electric power consumption occurs. It should be noted that the capacitor C51 for electric power recovery has a capacitance which is sufficiently larger than the interelectrode capacitance, and is charged with about a half (Vs/2) of the sustain pulse voltage Vs to enable the capacitor C51 to serve as the electric power supply for the electric power recovery section 50a.

In the voltage clamping section 50b, the switching element Q55 is turned ON to connect the scan electrodes SC1˜SCn to be driven to the electric power supply, and the applied voltage is clamped to the sustain pulse voltage Vs. In addition, the switching element Q56 is turned ON to electrically ground the scan electrodes SC1˜SCn to be driven and the voltage is clamped to 0V. Therefore, the impedance generated by the voltage clamping section at the time of voltage application is low, and a large discharge current caused by strong sustain discharge can be flowed stably.

As should be appreciated from the above, in the sustain pulse generating circuit 50, the sustain pulse voltage Vs is applied to the scan electrodes SC1˜SCn by controlling the switching elements Q51, Q52, Q55, and Q56. As these switching elements, elements generally known, such as MOSFETs, IGBTs, and the like, may be used.

The reset waveform generating circuit 60 includes a rising ramp voltage application circuit 61 for applying to the scan electrodes SC1˜SCn a ramp waveform voltage gradually rising with time in the reset period, a falling ramp voltage application circuit 62 for applying to the scan electrodes SC1˜SCn a ramp waveform voltage gradually falling with time in the reset period, and switching elements Q63 and Q64. In this embodiment, as the rising ramp voltage application circuit 61 and the falling ramp voltage application circuit 62, mirror integration circuits may be used, for example. The mirror integration circuit 61 includes a switching element Q61 such as a FET which is connected at the input side (drain terminal) of a main terminal to the electric power supply and connected at the output side (source terminal) of the main terminal to the scan electrodes SC1˜SC1080, a resistor R61 connected at one end to the control terminal (gate terminal) of the switching element Q61 and having an input terminal IN1 at the other end, and a capacitor C61 connected at one end to the control terminal of the switching element Q61 and connected at the other end to the input side (drain terminal) of the main terminal of the switching element Q61. The mirror integration circuit 62 includes a switching element Q62 such as FET which is connected at the input side (source terminal) of the main terminal to the electric power supply and connected at the output side (drain terminal) of the main terminal to the scan electrodes SC1˜SC1080, a resistor R62 connected at one end to the control terminal (gate terminal) of the switching element Q62 and having an input terminal IN2 at the other end, and a capacitor C62 connected at one end to the control terminal of the switching element Q62 and connected at the other end to the input side (source terminal) of the main terminal of the switching element Q62. When the ramp waveform voltage gradually rising from the voltage Vi1 which is not higher than the discharge start voltage toward the voltage Vi2 which exceeds the discharge start voltage is applied to the scan electrodes SC1˜SCn in the reset period, the input terminal IN1 of the rising ramp voltage application circuit 61 is set to Hi. To be specific, when the switching element Q61 is constituted by a FET, a predetermined positive voltage is applied to the input terminal IN1. Thereby, a constant current flows from the resistor R61 toward the capacitor C61, the voltage (source voltage) at the output side of the main terminal of the switching element Q61 rises in a ramp shape, and the voltage applied to the scan electrodes SC1˜SCn also rises in a ramp shape. After the output voltage reaches the voltage Vi3, the input terminal IN1 is set to Lo. To be specific, 0V is applied to the input terminal IN1. When the ramp waveform voltage (first ramp voltage having the first ramp waveform in this embodiment) gradually falling from the voltage Vi3 which is not higher than the discharge start voltage toward the voltage Vi4 which exceeds the discharge start voltage is applied to the scan electrodes SC1˜SCn, the input terminal IN2 of the falling ramp voltage application circuit 62 is set to Hi. To be specific, a predetermined positive voltage is applied to the input terminal IN2. Thereby, a constant current flows from the resistor R62 toward the capacitor C62, the voltage (drain voltage) at the output side of the main terminal of the switching element Q62 falls in a ramp shape, and the voltage applied to the scan electrodes SC1˜SCn falls in a ramp shape. After the output voltage reaches the voltage Vi4, the input terminal IN2 is set to Lo. To be specific, 0V is applied to the input terminal IN2. In this way, the falling ramp voltage application circuit 62 and the timing generating circuit 45 serve as a first ramp voltage application means in this embodiment. The switching elements Q63 and Q64 are separate switches and are provided to prevent the back flow of a current via parasitic diodes of the switching elements included in the sustain pulse generating circuit 50 and the reset waveform generating circuit 60.

The scan pulse generating circuit 70 includes switching elements Q71H1˜Q71Hn and Q71L1˜Q71Ln through which the scan pulse voltage Va is applied to the scan electrodes SC1˜SCn as desired. For example, the switching elements Q71H2 and Q71L2 are used to apply the scan pulse voltage Va to the scan electrode SC2. The scan pulse generating circuit 70 sequentially applies the scan pulse voltage Va to the scan electrodes SC1˜SCn at the above described timings.

FIG. 6 is a circuit diagram of the sustain electrode driving circuit 44 of the plasma display apparatus 110 according to Embodiment 1 of the present invention. As shown in FIG. 6, the sustain electrode driving circuit 44 of the plasma display apparatus 110 of Embodiment 1 includes a sustain pulse generating circuit 80 and a rising ramp voltage application circuit 90.

The sustain pulse generating circuit 80 is a circuit for applying the sustain voltage pulse to the sustain electrodes SU1˜SUn. The sustain pulse generating circuit 80 includes a capacitor C81 for electric power recovery, switching elements Q81 and Q82, back flow prevention diodes D81 and D82, and a resonance inductor L81 constituting an electric power recovery section 80a, and switching elements Q85 and Q86 constituting the voltage clamping section 80b. Since the sustain pulse generating circuit 80 is similar in configuration to the sustain pulse generating circuit 50, the operation will not be described in detail. The sustain pulse generating circuit 50 of the scan electrode driving circuit 43, the sustain pulse generating circuit 80 of the sustain electrode driving circuit 44 and the timing generating circuit 45 serve as a sustain voltage pulse application means of this embodiment.

The rising ramp voltage application circuit 90 is a circuit for applying a ramp waveform voltage gradually rising to the sustain electrodes SC1˜SCn in the reset period. In this embodiment, as the rising ramp voltage application circuit 90, a mirror integration circuit may be used, for example. The rising ramp voltage application circuit 90 has a configuration similar to that of the above described rising ramp voltage application circuit 61 of the scan electrode driving circuit 43. The mirror integration circuit 90 includes a switching element Q90 such as FET which is connected at the input side (source terminal) of a main terminal to the electric power supply and connected at the output side (drain terminal) of the main terminal to the scan electrodes SC1˜SCn, a resistor R90 which is connected at one end to the control terminal (gate terminal) of the switching element Q90 and has an input terminal IN3 at the other end, and a capacitor C90 which is connected at one end to the control terminal of the switching element Q90 and connected at the other end to the input side (source terminal) of the main terminal of the switching element Q90. The rising ramp voltage application circuit 90 further includes a diode D90 connected to the output side of the main terminal of the switching element Q90 to block the current flowing from the sustain pulse generating circuit 80. The rising ramp voltage application circuit 90 and the timing generating circuit 45 serve as a second ramp voltage application means of this embodiment. The second ramp voltage application means applies to the sustain electrodes SU1˜SUn the second ramp voltage gradually rising toward the voltage Ve in the reset period, and applies the positive voltage Ve to the sustain electrodes SU1˜SUn in the write period.

Although the ramp of rising of the positive voltage Ve applied to the sustain electrodes SU is set substantially equal in the total reset period in the first sub-field SF1 and in the selective reset periods in the second sub-field SF2 and the following sub-periods in Embodiment 1, the ramp of rising may be set steeper in the total reset period. This is because stable and weak discharge is generated without being affected by the ramp of rising of the positive voltage Ve, since the ramp voltage waveform gradually rising from the voltage Vi1 which is not higher than the discharge start voltage toward the voltage Vi2 which exceeds the discharge start voltage has been already applied to the scan electrodes SC in the total reset period. If the ramp of rising of the positive voltage Ve is made different between the total reset period and the selective reset period, then the configuration of the rising ramp voltage application circuit 90 shown in FIG. 6 becomes more complex. Therefore, the configuration in which the ramp waveform of rising of the positive voltage Ve is set equal in the total reset period and the selective reset period is attained easily and at a low cost.

### Embodiment 2

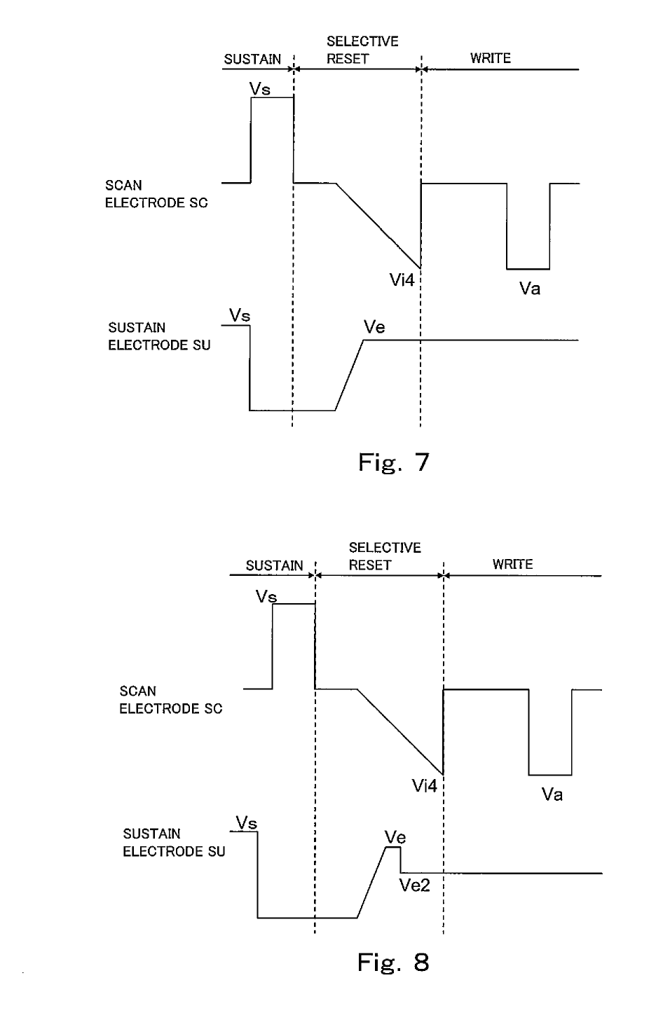

FIG. 7 is a view showing driving voltage waveforms of a driving method of a plasma display panel according to Embodiment 2 of the present invention. Embodiment 2 is different from Embodiment 1 in that in the selective reset period, the first ramp voltage and second ramp voltage are applied such that the second ramp waveform reaches a predetermined first voltage Ve and finishes rising before the first ramp waveform reaches a predetermined voltage Vi4 and finishes rising. In Embodiment 2, also, it is supposed that the panel 10 shown in FIGS. 1 and 2 is driven. Since the total reset period, the write period, and the sustain period of Embodiment 2 are similar to those of Embodiment 1, detailed description thereof will be omitted.

In Embodiment 2, as shown in FIG. 7, in the selective reset period, the first ramp voltage having a first ramp waveform gradually falling toward the voltage Vi4 which exceeds the discharge start voltage is applied to the scan electrodes SC, and a second ramp voltage having a second ramp waveform gradually rising toward the positive voltage Ve is applied to the sustain electrodes SU. The first ramp voltage having the first ramp waveform and the second ramp voltage having the second ramp waveform start rising substantially at the same time. In Embodiment 2, control is executed so that the second ramp voltage having the second ramp waveform reaches the predetermined constant voltage Ve at an earlier timing and thereafter the first ramp voltage having the first ramp waveform reaches the voltage Vi4. For example, the control is executed so that the second ramp voltage having the second ramp waveform reaches the voltage Ve at a time which is about 50 μsec earlier than the time when the first ramp voltage having the first ramp waveform reaches the voltage Vi4.

Since in Embodiment 2, it is necessary to generate weak discharge between the scan electrodes SC and the data electrodes D and between the scan electrodes SC and the sustain electrodes SU, using the first ramp voltage having the first ramp waveform and the second ramp voltage having the second ramp waveform, it is necessary to control the first ramp waveform and the second ramp waveform within a range illustrated in Embodiment 1.

In accordance with the driving method of the plasma display panel of Embodiment 2, the advantage similar to that of Embodiment 1 is achieved. In addition, since only the weak discharge caused by the first ramp voltage having the first ramp waveform is generated independently even after the second ramp voltage having the second ramp waveform reaches the voltage Ve and the weak discharge between the scan electrode SC and the sustain electrode SU stops, enabling the accumulation of the wall voltages which are less in variation and stable on the scan electrodes SC and the data electrodes D which are used for the write operation. Therefore, in Embodiment 2, more stable write operation can be achieved in the write period subsequent to the selective reset period.

The voltage waveforms in Embodiment 2 shown in FIG. 7 can be easily achieved by changing a constant of the capacitor C90 or the resistor R90 in the mirror integration circuit which is the rising ramp voltage application circuit 90 in the sustain electrode driving circuit 44 shown in FIG. 6, for example.

### Embodiment 3

FIG. 8 is a view showing driving voltage waveforms of a driving method of a plasma display panel according to Embodiment 3 of the present invention. Embodiment 3 is different from Embodiment 2 in that after the second ramp voltage reaches the first voltage Ve, the second voltage Ve2 lower than the first voltage Ve is applied to the sustain electrodes SU. In Embodiment 3, also, it is supposed that the panel 10 shown in FIGS. 1 and 2 is driven. Since the total reset period, the write period, and the sustain period of Embodiment 3 are similar to those of Embodiment 1 and Embodiment 2, detailed description thereof will be omitted.

In Embodiment 3, as shown in FIG. 8, in the selective reset period, the second ramp voltage having the second ramp waveform which is applied to the sustain electrodes SU gradually rises toward the positive first voltage Ve. After the second ramp voltage reaches the first voltage Ve, it maintains the voltage Ve for a specified period. Afterwards, the second ramp voltage falls to the second voltage Ve2 and maintains the second voltage Ve2. The first ramp voltage having the first ramp waveform which is applied to the scan electrodes SC is similar to that of Embodiment 2. The second ramp voltage reaches the first voltage Ve and then changes to the second voltage Ve2 before the first ramp voltage reaches the voltage Vi4.

In accordance with the driving method of the plasma display panel according to Embodiment 3, since the second ramp voltage applied to the sustain electrodes SU falls from the first voltage Ve to the second voltage Ve2, it is possible to optimally control the intensity of write discharge in the write period. After the second ramp voltage applied to the sustain electrodes SU falls to the second voltage Ve2 to pause the weak discharge, the weak discharge is generated again using the first ramp voltage having the first ramp waveform rising successively. By changing the timing when the second ramp voltage falls to the second voltage Ve2, the wall charge accumulated on the scan electrodes SC and the wall charge accumulated on the sustain electrode SU can be controlled precisely.

In general, if the intensity of the write discharge is too high, then the wall voltage accumulated on adjacent discharge cells is consumed, and as a result, the adjacent discharge cells cannot be turned ON correctly, which is called crosstalk. To prevent occurrence of the crosstalk, it is necessary to optimally control the intensity of the write discharge. Accordingly, in Embodiment 3, the second voltage Ve2 is optimally set so that the wall voltage accumulated on the scan electrodes SC and the wall voltage accumulated on the sustain electrodes SU can be controlled properly. This makes it possible to optimally control the write discharge so that the intensity of the write discharge is not too high. As a result, a more stable write operation can be achieved, and crosstalk which would degrade an image quality can be suppressed.

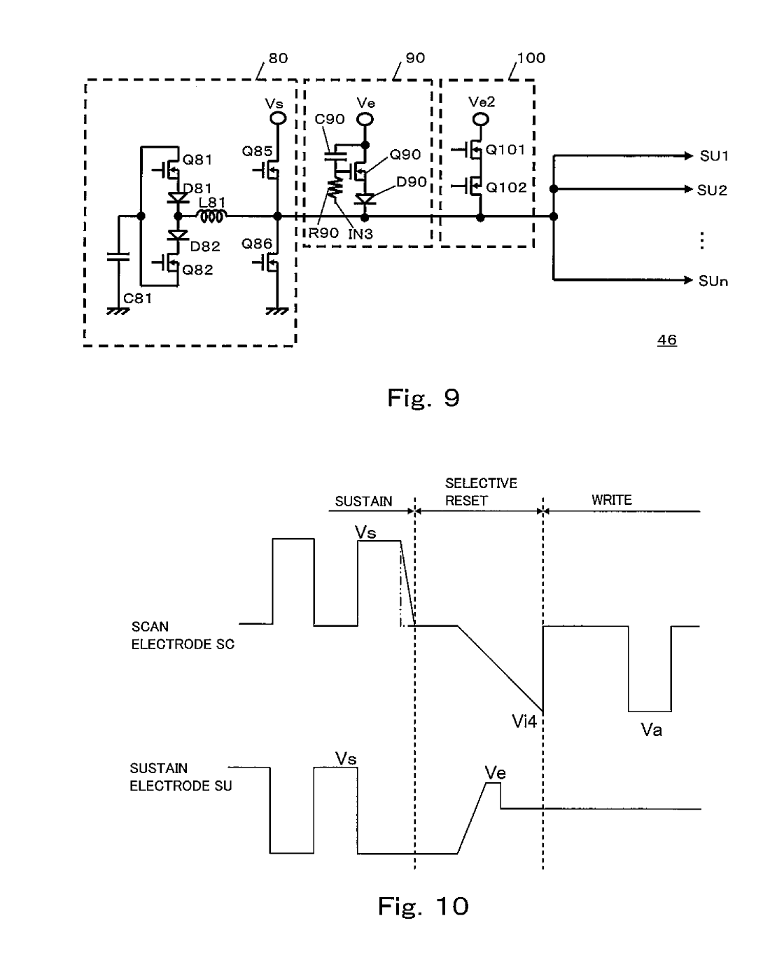

FIG. 9 is a circuit diagram of a sustain electrode driving circuit according to Embodiment 3 of the present invention. As shown in FIG. 9, a sustain electrode driving circuit 46 of Embodiment 3 includes a sustain pulse generating circuit 80, a rising ramp voltage application circuit 90, and a constant voltage application circuit 100. By tuning ON the constant voltage application circuit 100 after the rising ramp voltage application circuit 90 is turned ON and the second ramp voltage reaches the first voltage Ve, the voltage waveforms in Embodiment 3 shown in FIG. 8 can be easily achieved. Since the sustain pulse generating circuit 80 and the rising ramp voltage application circuit 90 shown in FIG. 9 are similar to the sustain electrode driving circuit 44 shown in FIG. 6, the constant voltage application circuit 100 will be described in detail hereinafter.

The constant voltage application circuit 100 includes two switching elements Q101 and Q102 which are opposite in polarity and are connected in series. In the selective reset period, the constant voltage application circuit 100 applies the positive voltage Ve2 to the sustain electrodes SU1˜SUn after the rising ramp voltage application circuit 90 applies the positive voltage Ve to the sustain electrodes SU1˜SUn. The constant voltage application circuit 100 and the timing generating circuit 45 (see FIG. 4) serve as a constant voltage application means in Embodiment 3. The switching elements Q101 and Q102 are connected in series to each other so as to be opposite in polarity. Thereby, the current can be controlled bidirectionally such that the current from the sustain pulse generating circuit 80 and the rising ramp voltage application circuit 90 can be blocked in the state where the voltage Ve2 is not applied, while the current from the panel 10 can be inflowed in the state where the voltage Ve2 is applied.

### Embodiment 4

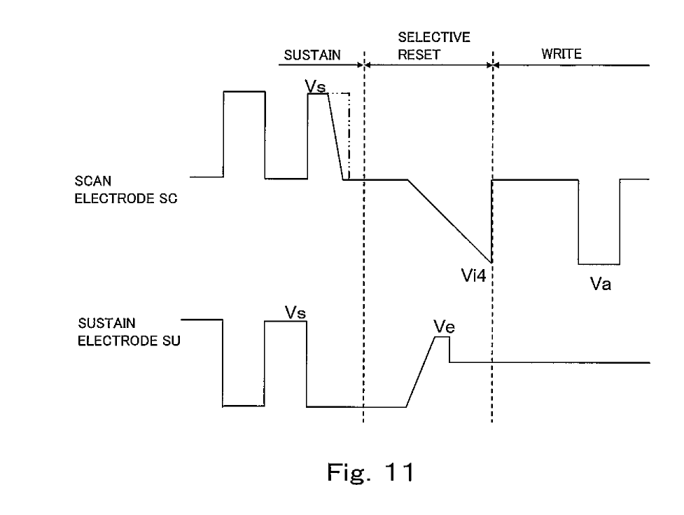

FIG. 10 is a view showing driving voltage waveforms of a driving method of a plasma display panel according to Embodiment 4 of the present invention. Embodiment 4 is different from Embodiment 3 in that the time period from when the last sustain pulse voltage starts falling until it finishes falling is longer than the time period from when other sustain pulse voltages start falling until they finish falling. In Embodiment 4, also, it is supposed that the panel 10 shown in FIGS. 1 and 2 is driven. Since the total reset period, the write period, and the selective reset period of Embodiment 4 are similar to those of Embodiment 3, detailed description thereof will be omitted.

If the last sustain pulse falls rapidly at the end of the sustain period, there is a possibility that the sustain discharge between the scan electrode SC and the sustain electrode SU may continue to be generated. In the present invention, the first ramp voltage having the first ramp waveform is applied to the scan electrodes SC and the second ramp voltage having the second ramp waveform is applied to the sustain electrodes SU so that the wall voltage accumulated on the scan electrodes SC and the wall voltage accumulated on the sustain electrodes SU with the last sustain pulse in the sustain period reach the voltages for generating optimal write discharge. In other words, it is very important to properly control the wall voltage accumulated with the last sustain pulse. Accordingly, in Embodiment 4, by setting the time period taken for the last sustain pulse to fall slower, the discharge between the scan electrodes SC and the sustain electrodes SU is suppressed, and thus, reduction of the wall voltage due to the discharge is avoided. This makes it possible to perform stable reset in a subsequent selective reset period and to achieve a more stable write operation. Although the time period taken for the last sustain pulse to fall is not particularly limited so long as the discharge is not generated at the above falling timing, it may be set to about 2 μsec, for example.

The voltage waveforms in the driving method of Embodiment 4 shown in FIG. 10 can be easily achieved by changing the operation timings of the switching elements Q52 and Q53 included in the sustain pulse generating circuit 50 in the scan electrode driving circuit 43 shown in FIG. 5 and by setting the electric power recovery time period longer only for the last sustain pulse, for example.

### Embodiment 5

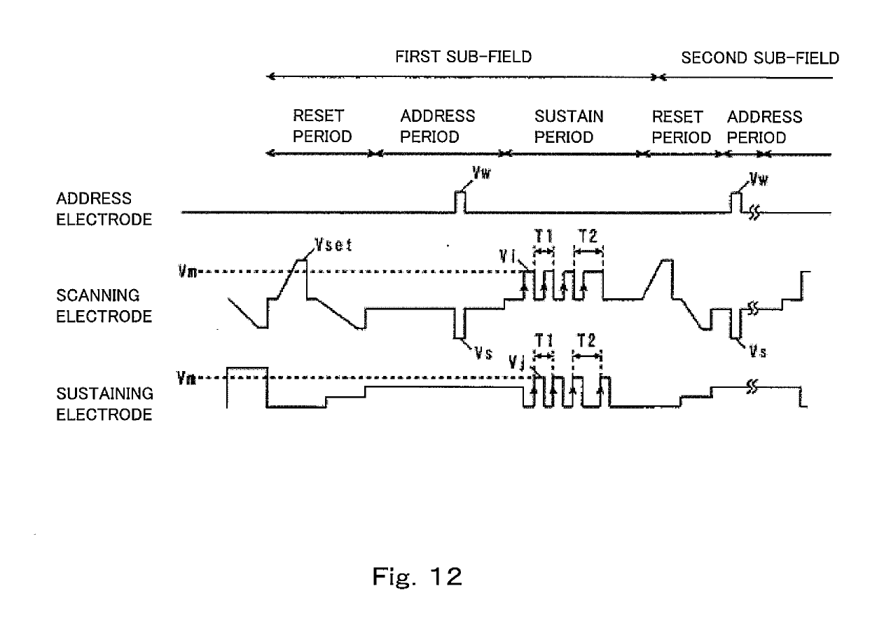

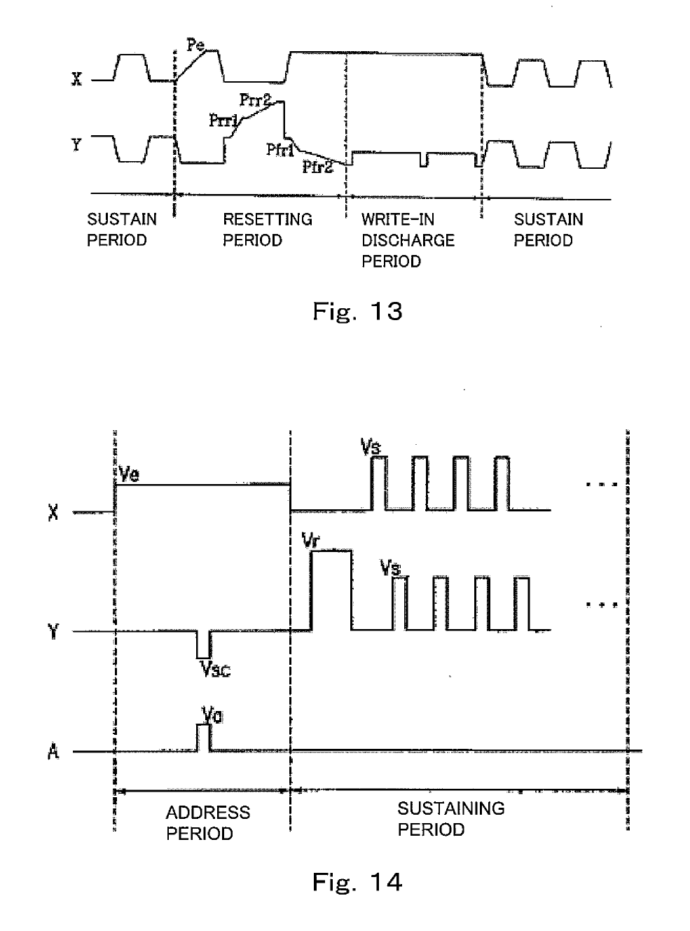

FIG. 11 is a view showing driving voltage waveforms of a driving method of a plasma display panel according to Embodiment 5 of the present invention. Embodiment 5 is different from Embodiment 4 in that the pulse width of the last sustain pulse is changeable with respect to the pulse width of the other sustain pulses. In Embodiment 5, also, it is supposed that the panel 10 shown in FIGS. 1 and 2 is driven. Since the total reset period, the write period, and the selective reset period of Embodiment 5 are similar to those of Embodiment 4, detailed description thereof will be omitted.

As described above, in the present invention, the first ramp voltage having the first ramp waveform is applied to the scan electrodes SC and the second ramp voltage having the second ramp waveform is applied to the sustain electrodes SU so that the wall voltage accumulated on the scan electrodes SC and the wall voltage accumulated on the sustain electrodes SU with the last sustain pulse in the sustain period reach the voltages for generating optimal write discharge. That is, it is very important to properly control the wall voltage accumulated with last sustain pulse. To this end, the pulse width of the last sustain pulse is made different from the pulse widths of the previous sustain pulses so that the wall voltage on the scan electrodes SC and the wall voltage on the sustain electrodes SU can be optimally controlled. As a result, the panel 10 can be controlled to be driven with a larger driving margin.

The voltage waveforms in the driving method of Embodiment 5 shown in FIG. 11 can be easily achieved in such a manner that in the scan electrode driving circuit 43 shown in FIG. 5, the operation timings of the switching elements Q52 and Q56 included in the sustain pulse generating circuit 50 are changed so that the pulse width of only the last sustain pulse is changed, for example.

The specific numeric values used in the above described Embodiment 1 to Embodiment 5 are merely exemplary and may be suitably set to optimal values according to the property of the PDP, the specification of the plasma display apparatus, etc.

Numeral modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the sprit of the invention.

### INDUSTRIAL APPLICABILITY

In accordance with the present invention, since in a selective reset period, ramp voltage waveforms are applied to scan electrodes and to sustain electrodes simultaneously, the time period taken for the selective reset period can be shortened. Therefore, the present invention is useful as a driving method of a plasma display panel and a plasma display apparatus using the driving method.

### EXPLANATION OF REFERENCE NUMERALS

10 panel

21 front substrate

22 scan electrode

22a, 23a transparent electrode

22b, 23b bus electrode

23 sustain electrode

24 display electrode pair

25, 33 dielectric layer

26 protective layer

29 black stripe

31 back substrate

32 data electrode

34 separating wall

35 phosphor layer

41 image signal processing circuit

42 data electrode driving circuit

43 scan electrode driving circuit

44, 46 sustain electrode driving circuit

45 timing generating circuit

50, 80 sustain pulse generating circuit

50a, 80a electric power recovery section

50b, 80b voltage clamping section

60 reset waveform generating circuit

61 rising ramp voltage application circuit

62 falling ramp voltage application circuit

70 scan pulse generating circuit

90 rising ramp voltage application circuit

100 constant voltage application circuit

110 plasma display apparatus

1. A method of driving a plasma display panel comprising plural display electrode pairs each including a scan electrode and a sustain electrode extending along each other, plural data electrodes crossing the plural display electrode pairs and discharge cells respectively formed at positions where the display electrode pairs and the data electrodes cross each other, comprising:
applying a last sustain voltage pulse to the scan electrode in a sustain period when a sustain voltage pulse is applied alternately to the scan electrode and to the sustain electrode;
then applying to the scan electrode a first ramp voltage having a first ramp waveform which is opposite in polarity to the last sustain voltage pulse; and
applying to the sustain electrode a second ramp voltage having a second ramp waveform which is opposite in polarity to the first ramp voltage such that before one of the first and second ramp waveforms reaches a predetermined voltage and finishes rising, the other of the first and second ramp waveforms starts rising,
wherein the first and second ramp voltages are applied such that the second ramp waveform reaches a predetermined first voltage and finishes rising before the first ramp waveform reaches the predetermined voltage and finishes rising.

2. (canceled)

3. The method of driving the plasma display panel according to claim 1, wherein after the second ramp voltage reaches the first voltage, a second voltage lower than the first voltage is applied to the sustain electrode.

4. The method of driving the plasma display panel according to claim 1, wherein a time period from when the last sustain voltage pulse starts falling until the last sustain voltage pulse finishes falling is longer than a time period from when other sustain voltage pulses start falling until the other sustain voltage pulses finish falling.

5. The method of driving the plasma display panel according to claim 1, wherein a pulse width of the last sustain voltage pulse is changeable with respect to pulse widths of other sustain voltage pulses.

6. A plasma display apparatus comprising:
plural display electrode pairs each including a scan electrode and a sustain electrode extending along each other;
plural data electrodes crossing the plural display electrode pairs;
discharge cells respectively formed at positions where the display electrode pairs and the data electrodes cross each other;
a control means configured to control a voltage applied to the display electrode pairs;
a first ramp voltage application means which is connected to the scan electrode and applies to the scan electrode the first ramp voltage having the first ramp waveform; and
a second ramp voltage application means which is connected to the sustain electrode and applies to the sustain electrode the second ramp voltage having the second ramp waveform; wherein
the control means is configured to apply a last sustain voltage pulse to the scan electrode in a sustain period when a sustain voltage pulse is applied alternately to the scan electrode and to the sustain electrode; then apply to the scan electrode a first ramp voltage having a first ramp waveform which is opposite in polarity to the last sustain voltage pulse; and apply to the sustain electrode a second ramp voltage having a second ramp waveform which is opposite in polarity to the first ramp voltage such that before one of the first and second ramp waveforms reaches a predetermined voltage and finishes rising, the other of the first and second ramp waveforms starts rising; and wherein
the control means causes the second ramp voltage application means to generate the second ramp waveform such that the second ramp waveform reaches a predetermined first voltage and finishes rising before the first ramp waveform generated by the first ramp voltage application means reaches the predetermined voltage and finishes rising.

7. (canceled)

8. The plasma display apparatus according to claim 6, further comprising:
constant voltage application means which is connected to the sustain electrode and applies a constant voltage of a second voltage lower than the first voltage; wherein
the control means turns ON the constant voltage application means, when the second ramp voltage reaches the first voltage after the control means turns ON the second ramp voltage application means.

9. The plasma display apparatus according to claim 6, further comprising:
a sustain voltage pulse application means which is connected to the scan electrode and applies a sustain voltage pulse to the scan electrode;
wherein the control means is configured to set, a time period from when the last sustain voltage pulse starts falling until the last sustain voltage pulse finishes falling, longer than a time period from when other sustain voltage pulses start falling until the other sustain voltage pulses finish falling.

10. The plasma display apparatus according to claim 6, further comprising:
a sustain voltage pulse application means which is connected to the scan electrode and applies a sustain voltage pulse to the scan electrode;
wherein the control means is configured to change a pulse width of the last sustain voltage pulse with respect to pulse widths of other sustain voltage pulses.
